(19) United States
(12) Patent Application Publication
(10) Pub. No.: US 2010/0163588 A1
(43) Pub. Date: Jul. 1, 2010

(54) Bicycle Lock Box

(76) Inventors: Eric Darnas, Marina del Rey, CA (US); Kenneth Kwak, Venice, CA (US)

Correspondence Address: TROJAN LAW OFFICES, 9250 WILSHIRE BLVD, SUITE 325, BEVERLY HILLS, CA, 90212, US

(21) Appl. No.: 12/625,367

(22) Filed: Nov. 24, 2009

Related U.S. Application Data
(63) Continuation-in-part of application No. 12/319,066, filed on Dec. 30, 2008.

(51) Int. Cl. B62J 9/00

(52) U.S. Cl. 224/431; 224/435

(57) ABSTRACT

A storage device having a lockable container for securely storing small items, attaches to the support frame of a bicycle or pole-like structure, and further serves as a holder for a bicycle lock. According to a preferred embodiment, the bicycle attachment element is lockable and is attachable to the bicycle frame only when the container is in an open position. Once the lock box is locked, it cannot be removed from the bicycle frame. Another preferred embodiment has protrusions capable of holding a cable lock in place on the exterior of the lockable container.

### RELATED PATENT APPLICATION

This application is a Continuation-In-Part application of application Ser. No. 12/319,066, filed Dec. 30, 2008.

### FIELD Of THE INVENTION

The present invention generally relates to storage devices, and in particular, to portable storage devices used by cyclists.

### BACKGROUND OF THE INVENTION

Cyclists often need to carry valuables, such as wallets, money, keys, and other items, while cycling. However, carrying such items, e.g. in a pocket or bag, while cycling is often inconvenient and/or uncomfortable. Sometimes, the bicycle frame is utilized as a convenient means for attaching various items that need to be transported, including storage containers for small items. Additionally, a bicycle lock is a standard item that is also attached to the frame during transport. However, as a rider desires to minimize the bulk and number of items carried on the frame, and may also desire to leave the items with the bicycle unattended, it is advantageous to find an improved device and method for conveniently transporting items while cycling, and for securely storing these items with an unattended bicycle.

### SUMMARY OF THE INVENTION

The present invention provides a storage device having a lockable container, and a bicycle attachment element that attaches to the support frame of a bicycle. Additionally, the device serves as a holder for a U-shaped bicycle lock and/or cable bicycle lock. The device allows a user to securely store small items such as keys, wallets, or other valuables, in the container while leaving the bicycle unattended (i.e., locked to a bicycle rack or post), and further can conveniently hold bicycle locks during transportation. According to a preferred embodiment, the bicycle attachment element is lockable and attachable to the bicycle frame only when the container is in an open position. Once the lock box is locked, it cannot be removed from the bicycle frame. In other embodiments, the bicycle attachment element can be locked and unlocked even if the container is in a closed position. Other embodiments of the invention provide for storage devices that are permanently secured onto the bicycle frame.

### BRIEF DESCRIPTION OF THE DRAWINGS

FIG. 1 is a perspective view of a storage device, in accordance with a first embodiment of the present invention, illustrated with the cover opened.

FIG. 2 is a perspective view of a common U-shaped bicycle lock, commonly known as a Kryptonite brand lock. FIG. 3 is a front perspective view of the device of FIG. 1, with the lock of FIG. 2 held around the device. The device is illustrated with the cover closed.

FIG. 3a illustrates a second embodiment for the container of FIG. 3, wherein the container has a downwardly curved bottom wall that conforms to the boundaries of the lock.

FIG. 4 is a top side perspective view of the device of FIG. 1, shown with the lock held by the device, and with the cover opened.

FIG. 5 illustrates the device of FIG. 1 attached to a bicycle.

FIG. 6 is a perspective view of a storage device, in accordance with a third embodiment of the invention. The device is illustrated with the cover opened, and without the lock.

FIG. 7 is a perspective back view of the embodiment shown in FIG. 6.

FIG. 8 is a top perspective view of a fourth embodiment of the invention.

FIGS. 9 and 10 are bottom perspective views of a fourth embodiment of the invention, showing the cover in the closed and open positions, respectively.

FIG. 11 is a perspective view of a storage device, in accordance with a fourth embodiment of the invention.

FIG. 12 is a perspective view of a storage device, in accordance with a fifth embodiment of the invention.

FIG. 13 is a perspective view of a storage device, in accordance with a sixth embodiment of the invention.

FIG. 14 is a side perspective view of a storage device, in accordance with a fourth embodiment of the invention.

### DETAILED DESCRIPTION OF THE INVENTION

The detailed description set forth below is intended as a description of exemplary embodiments and is not intended to represent the only forms in which the exemplary embodiments may be constructed and/or utilized. The description sets forth the functions and the sequence of steps for constructing and/or operating the exemplary embodiments. However, it is to be understood that the same or equivalent functions and sequences may be accomplished by different exemplary methods are also intended to be encompassed within the spirit and scope of the invention.

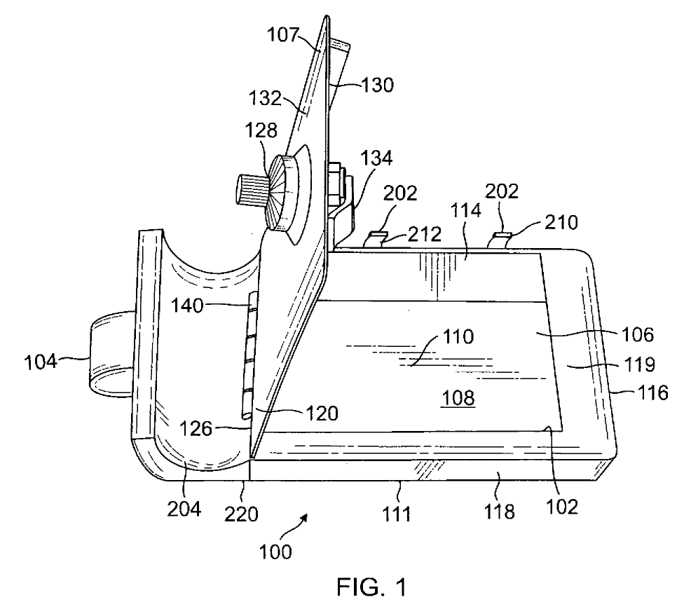

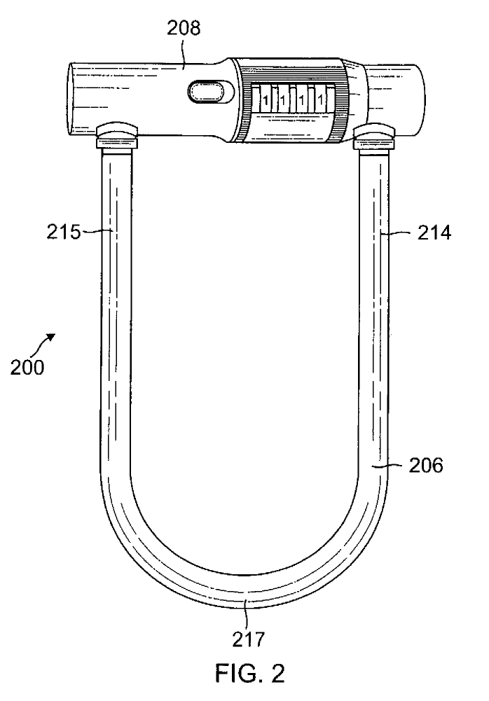

Illustrated in FIG. 1 is a storage device 100 including a lockable container 102, in accordance with a first preferred embodiment of the invention. The device 100 further includes a bicycle attachment element 104, for attachment of the device 100 to the frame of a bicycle, and retaining members 202 and 204, for retaining a U-shaped bicycle lock 200, such as the commonly known Kryptonite brand lock (see FIG. 2).

The container 102 includes a storage portion 106, and cover 107. The storage portion 106 comprises a flat rectangular back panel 108, having opposite inner and outer sides with surfaces surface 110 and 111, and side walls 114, 116, 118, and 120, extending perpendicularly from the inner side of the panel 108 to form storage portion 106.

The cover 107, comprises a flat panel having inner and outer opposite sides, 130 and 132, respectively, and is hinged to the top portion 126 of wall 120 via a hinge element 140. The cover further includes a combination lock 128. The lock 128 includes a combination pad on the outer side 132 of the cover, and latch 134 on the inner side 130, which engages a top extension panel 119 of the wall 116, when the box is locked.

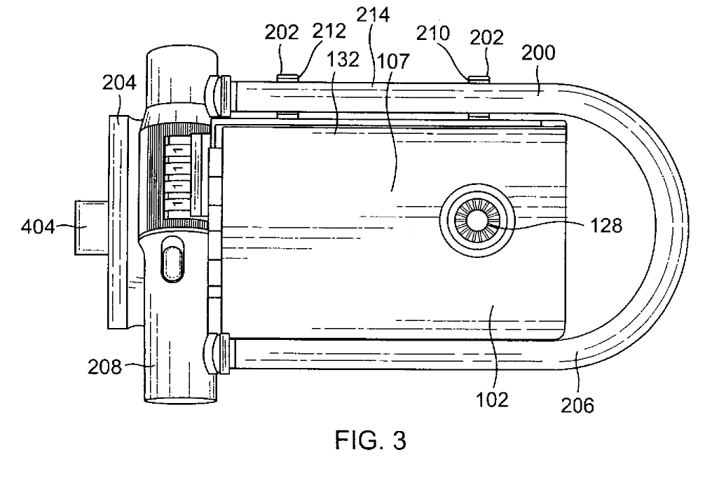

The outer sides of walls 114 and 120 further include holding elements comprising retaining members 202 and 204, for engaging a standard bicycle lock, such as a Kryptonite lock 200, as shown in FIG. 3. The lock 200, shown in FIG. 2, includes a U-shaped portion 206, having an open top end, opposing first and second straight side segments 214 and 215, with a bottom arc 217 extending downwardly from and between the side segments, and a cylindrical locking bar 208 across the top of the U.

It should be understood that the geometric shape or design of the container may vary, without departing from the scope of the present invention. For example, the container may include a geometric configuration having a downwardly curved bottom wall 303 instead of the straight wall, as illustrated in FIG. 3a, which shows a second preferred embodiment of the invention. The design of FIG. 3a maximizes the surface area of 20 the container, within the boundaries of the Kryptonite lock. Alternatively, the bottom wall 303 may be upwardly curved to create a circular space between the lock and wall, which may be suitable for a cylindrical container such as a water bottle or can. Preferably, the geometric configuration of the container comprises at least four sides, which may include straight walls or one or more curved walls (as a curved wall has infinite sides). Other configurations will be 5 apparent to one skilled in the art.

Referring back to FIG. 3, holding element comprising first and second retaining members, 202 and 204, capable of receiving and releasably clasping the side segments and top locking bar, respectively. First retaining member 202 includes two generally semi-circular segments 210 and 212 for retaining one of the straight segments (e.g., 214) of the portion 206, 10 on one side of the U. Additionally, second retaining member 204 comprises a generally semicircular tubular member approximately spanning the width of the container 102, and having a back panel 220 that is an integral extension of panel 108. Thus, retaining member 204 engages a relatively larger portion of the locking bar 208 as compared to the section engaged by retaining member 202. The lock 200 snaps into retaining members 202 and 204, and is held 15 in place around the container 102.

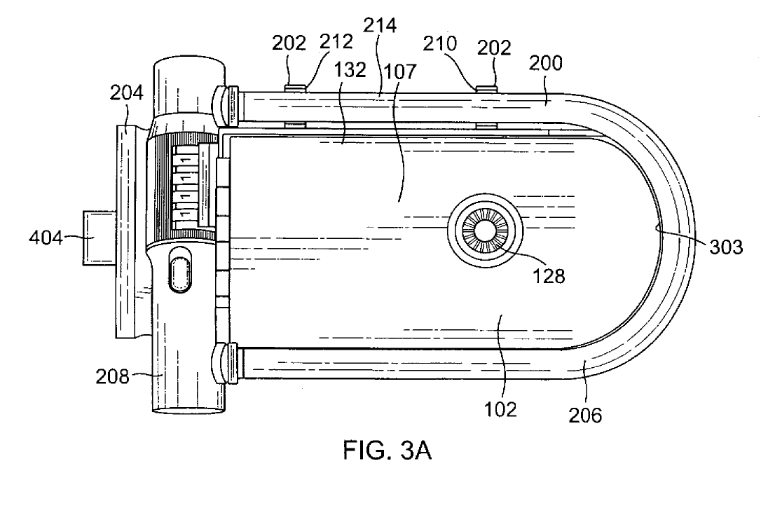

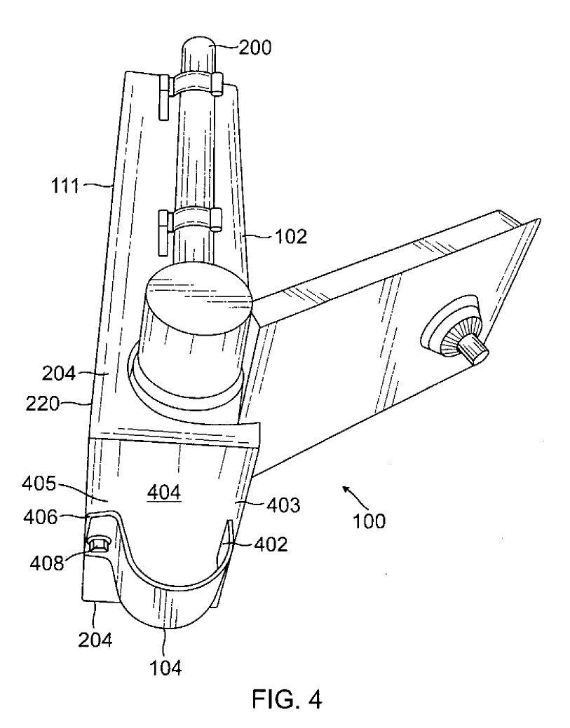

With specific reference to FIG. 4, attachment element 104 comprises a band having a first leg 402 firmly affixed to around a frontal section 403 of an outer side panel 404 of retaining member 204, and a second leg 406, affixed around a posterior section 405 of panel 404, forming an arc protruding from panel 404. The second leg 406 is held in place by a bolt 20 or screw 408, which can be removed for creating an opening between panel 404 and attachment element 104, such that element 104 can be wrapped around the support frame 500 of a bicycle 501 for attaching device 100, as illustrated in FIG. 5. Once element 104 is wrapped around the frame, the screw 408 is replaced and tightened to firmly attach the device. The device 100 can thus be attached to the vertical, diagonal, or horizontal section of the frame 500. In this embodiment, a flexible rigid material such as metal or plastic is most suitable for the manufacture of the band of element 104.

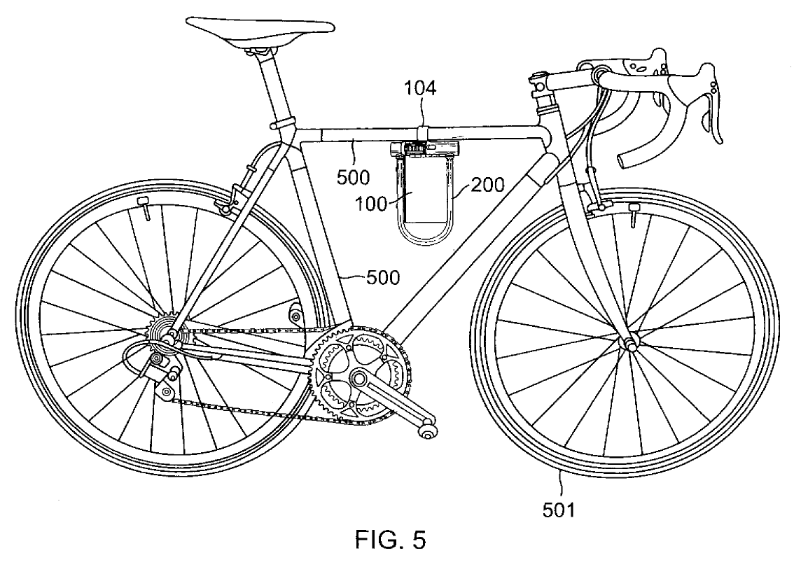

According to a third preferred embodiment of the invention, shown in FIG. 6, the device 100 includes an attachment element 600, which is lockable and attachable to the bicycle frame only when the container 102 is in an open position. Once the lock box is locked, the attachment element 600 can also be locked into place such that it cannot be removed from the bicycle frame.

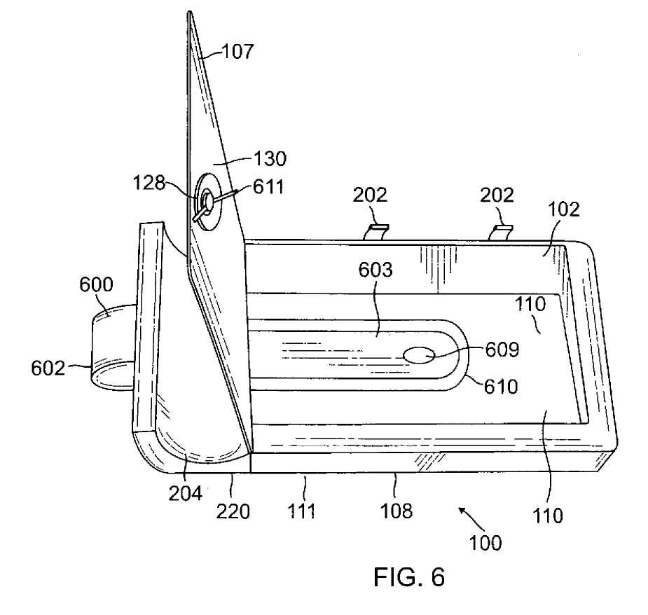

As illustrated in the FIGS. 6 and 7, a second version of the attachment element 600 is a band having a top arc portion 602, and a tongue 603 that extends from the arc into the container 102 through panels 220 and 108 of holding element 204 and container 102 respectively.

Element 600 is slidable up and down (indicated by arrow 601) between an open position (shown in FIG. 7), which provides clearance space between the arc 602 and panel 404 for affixing the device 100 to the bicycle frame, and a closed position which securely locks the element to the frame. The arc 602 has a leg or edge 604 that abuts top section 403 of the outer side panel 404 in the closed position. The edge 604 is not affixed to the panel 404, but rather either rests against it, or inserts into a slot or trench 606 provided on the panel 404.

Tongue 603 includes a hole 609 that locks element 600 in place by insertion of a locking latch such as rod 611 extending from the inner side 130 of the cover 107. Thereby, element 600 can be affixed by closing the cover 107 with rod 611 engaged within the hole 609. Although rod 611 is shown extending from the lock 128, it may extend from any location on the cover.

Other varied mechanisms for locking tongue 603 in place when the cover 107 is in closed position will be obvious to one skilled in the art, and are within the intended scope of this invention.

Preferably, a recessed track 610 extends from an insertion slot 612, provided on panel 404, through panels 220 and 108, allowing the tongue 603 to slide up and down on the track. The track is embedded through the panels, and may be entrenched and fully exposed through surface 110 of panel 108, or mostly embedded within both panels, as long as at least a section exposing the hole 609 of the tongue is exposed, such that it may be lockably engaged via rod 611 when the element 600 is in the closed position.

Similar to attachment element 104, attachment element 600 is preferably made of a rigid material, such as metal or plastic.

It should further be understood that the holding and attachment elements may vary in width and placement around the container. Additionally, the container cover may be hinged or otherwise connected at any of the walls, or may be unconnected, such that it is entirely removable when the box is opened, but still lockable. Additionally, other types of locking mechanisms, such as a key lock, are within the scope of the invention. The device 100 is preferably made of metal, but may also be made of other suitable rigid materials such as plastic, composites, etc.

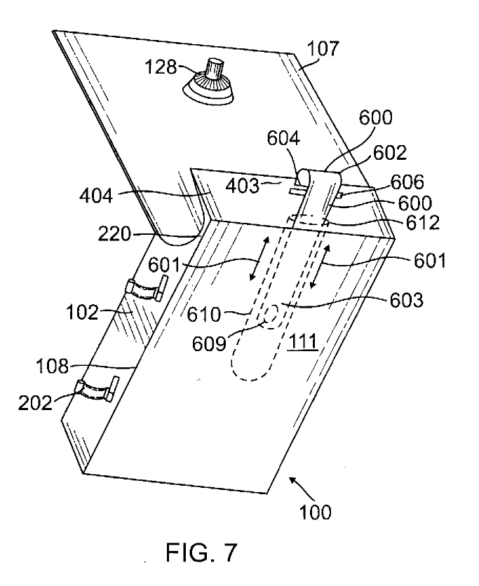

According to a fourth preferred embodiment of the invention, shown in FIGS. 8 to 12, the device 100 can be fashioned in a non-rectangular form (e.g., cylindrical). This embodiment features protrusions 701, each aligned with another protrusion and preferably located at opposite ends of the storage device. The protrusions have a concave end 702, which provides a surface for the bicycle frame or the Kryptonite lock to rest.

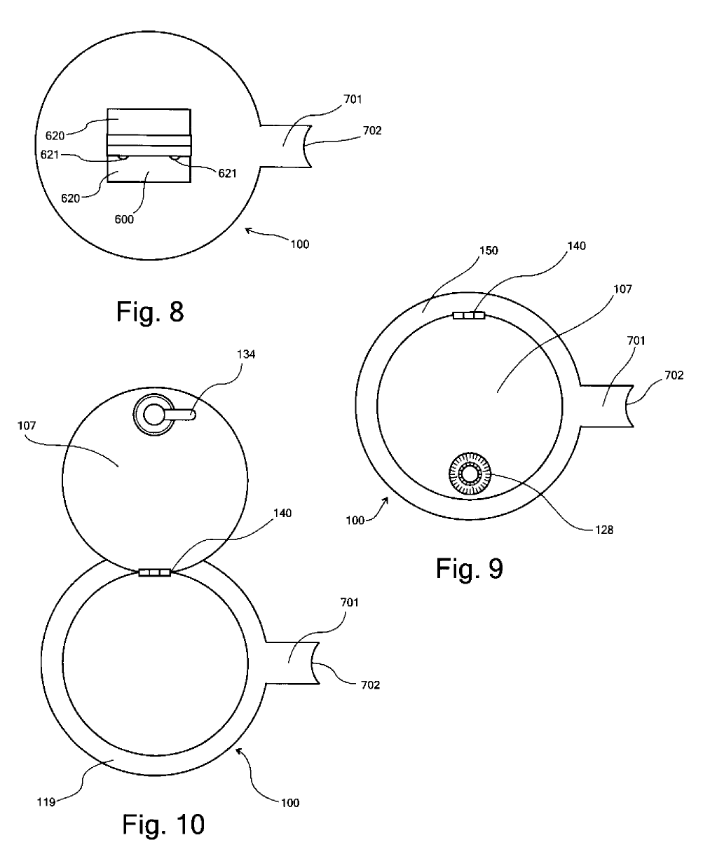

FIG. 8 shows a third version of the attachment element 600. This version of the attachment element 600 consists of two half-pipe structures 620 that are attached to each other by one-way screws 621 or other attachment methods (e.g., a lock, rivets, adhesives). FIG. 9 shows the container cover 107 in a closed position. The container cover 107 is attached to the main body 150 of the device by the container cover hinge 140. The combination lock 128 locks the cover 107 while a closed position. FIG. 10 shows the container cover 107 in an open position. As shown, the latch 134 on the interior side of the container cover 107 can engage with the extension panel 119, thereby locking the container cover 107 while in the closed position.

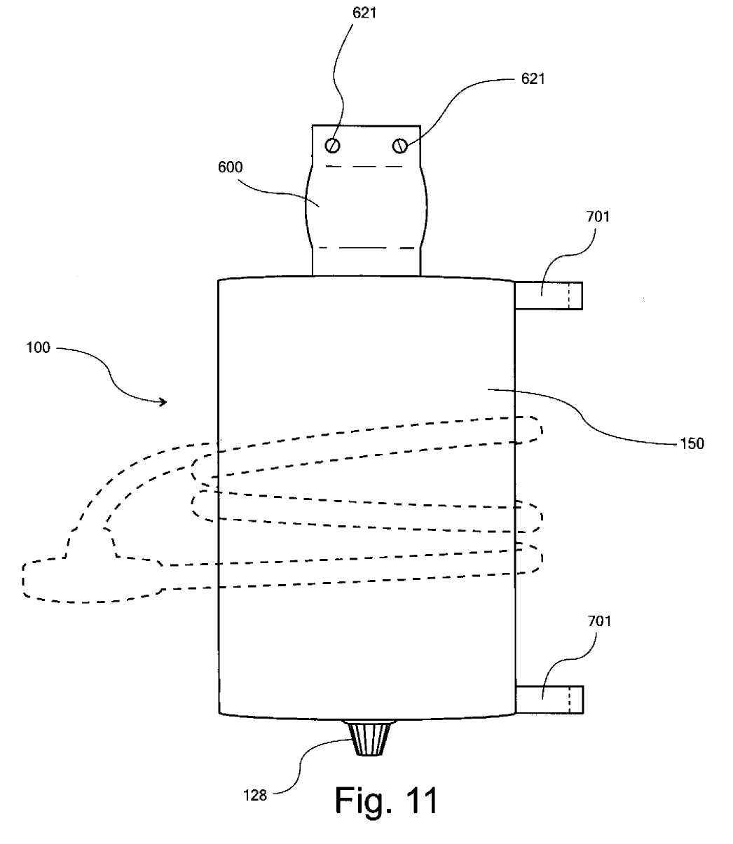

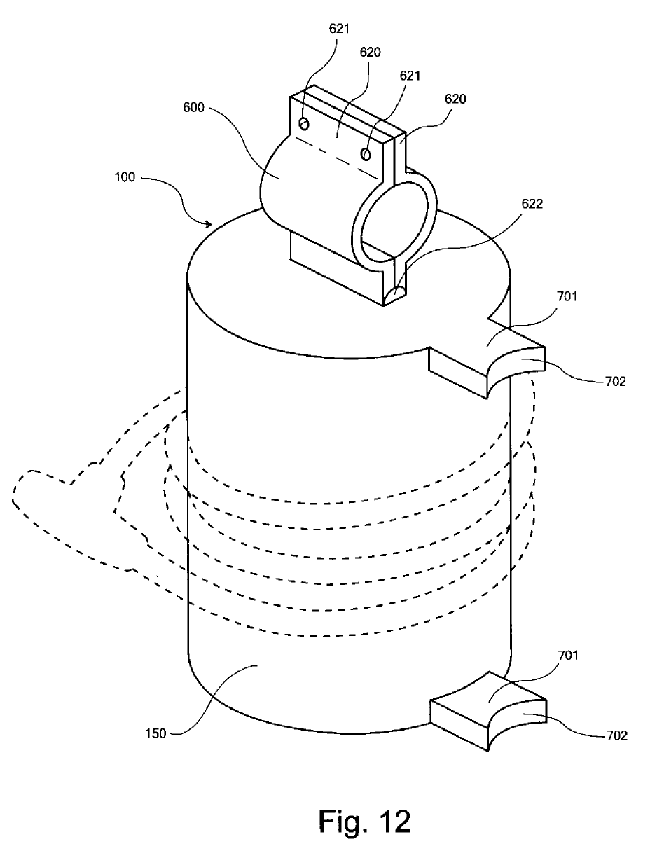

FIG. 11 is a side perspective view of the storage device 100. As shown, a bicycle cable lock can be wrapped around the main body 150 while the cable lock is not in use. The cable lock is prevented from falling off the storage device 100 by the protrusions 701. FIG. 12 shows that the two half-pipe structures 620 are attached to the main body 150 by an attachment element hinge 622, thereby forming the clamp-like attachment element 600. The attachment element 600 can be attached to, for example, the bicycle frame, the Kryptonite lock, or to a sign post.

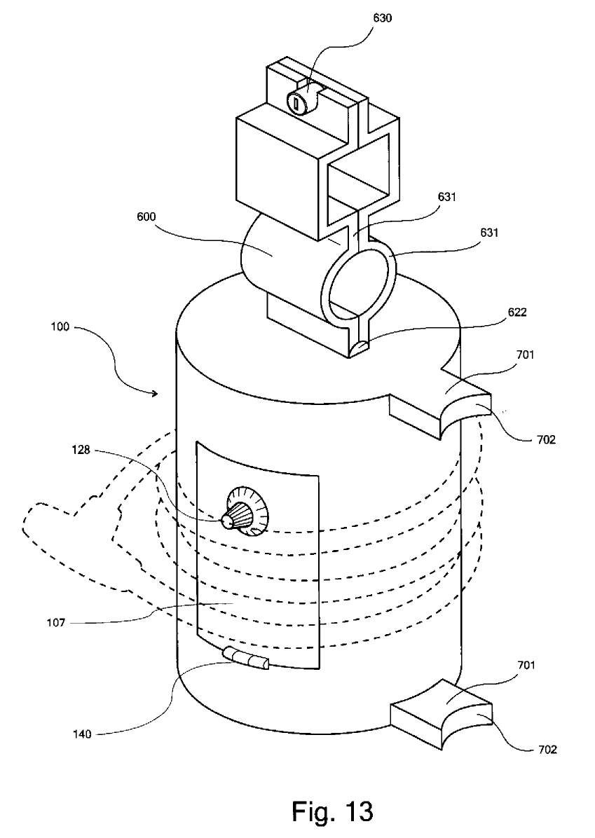

FIG. 13 shows a fifth embodiment of the invention, which features an attachment element 600 with two half-pipe structures 631 with a double set of half-pipes. As shown in this embodiment, half-pipes do not necessarily have to be semicircular in form. In this embodiment, the storage device 100 can be attached to multiple objects (e.g., it can be attached to both the bicycle frame as well as the Kryptonite lock). FIG. 13 also shows an alternate method of securing the two half-pipe structures 620 together. Here, a key lock 630 is used to attach the two half-pipe structures 620. The key lock 630 or a similar device is advantageous for situations that require non-permanent methods of attachment.

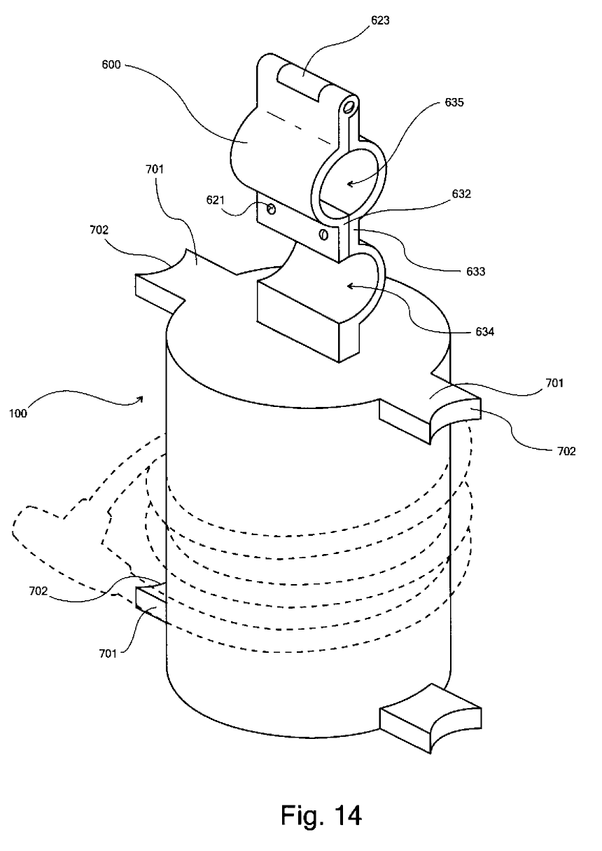

FIG. 14 shows a sixth embodiment of the invention, which features an attachment element 600 with a half-pipe structure 632 attached to a double half-pipe structure 633. The two half-pipe structures 632/633 are joined at one end by a hinge 623. The two half-pipe structures 632/633 can be secured by one-way screws 621 or other attachment methods. This attachment element 600 provides an open-ended half-pipe section 634 to temporarily hold an object like the Krytonite lock. The attachment element 600 can also more permanently hold an object in the closed section 635 between the two half-pipe structures 632/633. Additional sets of protrusions 701 can help hold the Kryptonite lock and/or cable lock in place. Combinations of features from this and other embodiments can be made to form other obvious embodiments.

In closing, it is to be understood that the exemplary embodiments described herein are illustrative of the principles of the present invention. Other modifications that may be employed are within the scope of the invention. Thus, by way of example, but not of limitation, alternative configurations may be utilized in accordance with the teachings herein. Accordingly, the description is illustrative and not meant to be a limitation thereof

What is claimed is:

1. A storage device, comprising:
a storage container having sidewalls running along a lengthwise axis, a front face perpendicular to said lengthwise axis, and a back face perpendicular to said lengthwise axis;
said storage container having a door with a lock;
a set of protrusions extending from said sidewalls;
said protrusions aligned along said lengthwise axis;
an attachment element formed from two half-pipe structures;
each of said half-pipe structures attached to said storage container by a hinge;
said half-pipe structures attached to each other;
wherein, said attachment element is capable of attaching to a rod-like structure, and said set of protrusions capable of holding a cable lock in place on an exterior side of said sidewall.

2. The storage device of claim 1, wherein one end of each protrusion has a concave surface.

3. The storage device of claim 1, wherein said half-pipe structures are attached to each other by one-way screws.

4. The storage device of claim 1, wherein said half-pipe structures are attached to each other by a weld.

5. The storage device of claim 1, wherein said half-pipe structures are attached to each other by a lock.

6. The storage device of claim 1, further comprising:
a second set of protrusions;
wherein, said second set of protrusions are aligned to the first set of protrusions on a second axis of said storage container.

7. The storage device of claim 6, wherein said second axis of said storage container is perpendicular to said lengthwise axis.

8. A storage device, comprising:
a storage container having sidewalls running along a lengthwise axis, a front face perpendicular to said lengthwise axis, and a back face perpendicular to said lengthwise axis;
said storage container having a door with a lock;
a set of protrusions extending from said sidewalls;
said protrusions aligned along said lengthwise axis;
an attachment element formed from two double half-pipe structures;
each of said double half-pipe structures attached to said storage container by a hinge;
said double half-pipe structures attached to each other;
wherein, said attachment element is capable of attaching to a rod-like structure, and said set of protrusions capable of holding a cable lock in place on an exterior side of said sidewall.

9. The storage device of claim 8, wherein one end of each protrusion has a concave surface.

10. The storage device of claim 9, wherein said door is located on said front face.

11. The storage device of claim 9, wherein said door is located on said sidewalls.

12. The storage device of claim 9, wherein said double half-pipe structures are attached to each other by a lock.

13. The storage device of claim 12, further comprising:
a second set of protrusions;
wherein, said second set of protrusions are aligned to the first set of protrusions on a second axis of said storage container.

14. The storage device of claim 13, wherein said second axis of said storage container is perpendicular to said lengthwise axis.

15. A storage device, comprising:
a storage container having sidewalls running along a lengthwise axis, a front face perpendicular to said lengthwise axis, and a back face perpendicular to said lengthwise axis;
said storage container having a door with a lock;
a set of protrusions extending from said sidewalls;
said protrusions aligned along said lengthwise axis;
an attachment element formed from a half-pipe structure and a double half-pipe structure;
said half-pipe structure is attached to said double half-pipe structure;
wherein, said attachment element is capable of attaching to a first rod-like structure, and said set of protrusions capable of holding a cable lock in place on an exterior side of said sidewall.

16. The storage device of claim 15, wherein one end of each protrusion has a concave surface.

17. The storage device of claim 16, wherein one end of said half-pipe structure is attached to one end of said double half-pipe structure by a hinge.

18. The storage device of claim 17, further comprising:
an open-ended half-pipe section located on said double half-pipe structure;
said half-pipe structure having an open position and a closed position;
wherein, when said half-pipe structure is in said closed position, said first rod-like structure is secured by said attachment element; and
said open-ended half-pipe section is capable of attaching to a second rod-like structure regardless of whether said half-pipe structure is in said closed position or said open position.

19. The storage device of claim 18, further comprising:
a second set of protrusions;
wherein, said second set of protrusions are aligned to the first set of protrusions on a second axis of said storage container.

20. The storage device of claim 19, wherein said second axis of said storage container is perpendicular to said lengthwise axis.
